(19) United States
(12) Patent Application Publication
(10) Pub. No.: US 2025/0148828 A1
(43) Pub. Date: May 8, 2025

(54) REAL-EYE DETECTION USING MULTIPLE POLARIZATION CONFIGURATIONS

(71) Applicant: FINGERPRINT CARDS ANACATUM IP AB, GÖTEBORG (SE)

(72) Inventors: Gabriel HINE, ROME (IT); Mikkel STEGMANN, VANLØSE (DK)

(73) Assignee: FINGERPRINT CARDS ANACATUM IP AB, GÖTEBORG (SE)

(21) Appl. No.: 18/838,377

(22) PCT Filed: Feb. 17, 2023
(86) PCT No.: PCT/SE2023/050145

§ 371 Date: Aug. 14, 2024

(30) Foreign Application Priority Data
Feb. 24, 2022 (SE) 2250248-8

(51) Int. Cl. G06V 40/18; G06F 21/32; G06V 40/40

(52) U.S. Cl. CPC G06V 40/193; G06F 21/32; G06V 40/197; G06V 40/40

(57) ABSTRACT

A method of a biometric recognition system of performing real-eye detection, and a biometric recognition system performing the method. The method includes capturing a first image, comprising a representation of an iris, that is captured utilizing polarized light reflected at the iris and received at a polarization-sensitive camera, the first image being captured with a first polarization configuration being applied, and capturing a second image, comprising a representation of the iris, that is captured utilizing polarized light reflected at the iris and received at a polarization-sensitive camera, the second image being captured with a second polarization configuration being applied. The method further comprises detecting, from the representations of the iris of the first and second images, whether birefringent features of a cornea are correctly rendered in both the first and the second image, and if so determining that the iris originates from a real eye.

### TECHNICAL FIELD

The present disclosure relates to a method of a biometric recognition system of performing real-eye detection, and a biometric recognition system performing the method.

### BACKGROUND

When capturing images of an eye of a user for performing iris recognition using for instance a camera of a smartphone for subsequently unlocking the smart phone of the user, subtle visual structures and features of the user's iris are identified in the captured image and compared to corresponding features of a previously enrolled iris image in order to find a match. These structures are a strong carrier of eye identity, and by association, subject identity.

Both during authentication and enrolment of the user, accurate detection of these features is pivotal for performing reliable iris recognition. However, iris recognition is susceptible to spoofing where an attacker e.g. may present a credible and detailed iris printout to an iris recognition system for attaining false authentication.

### SUMMARY

One objective is to solve, or at least mitigate, this problem in the art and thus to provide an improved method of a biometric recognition system of performing real-eye detection.

This objective is attained in a first aspect by a method of a biometric recognition system of performing real-eye detection. The method comprises capturing a first image comprising a representation of an iris, which first image is captured utilizing polarized light reflected at the iris and received at a polarization-sensitive camera capturing said first image, the first image being captured with a first polarization configuration being applied and capturing a second image comprising a representation of the iris, which second image is captured utilizing polarized light reflected at the iris and received at a polarization-sensitive camera capturing said second image, the second image being captured with a second polarization configuration being applied. The method further comprises detecting, from the representations of the iris of the first and second images, whether birefringent features of a cornea are correctly rendered in both the first and the second image, and if so determining that the iris originates from a real eye.

This objective is attained in a second aspect by a biometric recognition system configured to perform real-eye detection. The system comprises a polarization-sensitive camera configured to capture a first image comprising a representation of an iris, which first image is captured utilizing polarized light reflected at the iris and received at a polarization-sensitive camera capturing said first image, the first image being captured with a first polarization configuration being applied and to capture a second image comprising a representation of the iris, which second image is captured utilizing polarized light reflected at the iris and received at a polarization-sensitive camera capturing said second image, the second image being captured with a second polarization configuration being applied. The system further comprises a processing unit configured to detect, from the representations of the iris of the first and second images, whether birefringent features of a cornea are correctly rendered in both the first and the second image, and if so to determine that the iris originates from a real eye.

Thus, by subjecting the iris of an individual to polarized light and capturing an image of the iris with a polarization-sensitive camera, so-called birefringent features of the cornea covering the iris will be present in the image. A spoof eye provided by an attacker, such as a paper printout, will not exhibit the birefringent cornea features and may thus be detected as a spoof.

Now, it may be possible that the attacker subjects to system to more complex and elaborated spoofing attempts, using so-called iris Presentation Attack Instruments (PAI) and in particular birefringent PAIs. Even though reproduction of a 3D material with similar birefringent properties as a real cornea is not currently feasible, it is possible to manufacture 2D PAIs that show similar patterns when illuminated with a particular target configuration, e.g. by providing a print-out of an iris with patches of birefringent material on top to create a structure similar to a cornea.

With such a PAI, it may be possible to spoof a real-eye detection, in particular if physical properties of the PAI is adapted to a particular polarization configuration of system.

By capturing at least two images of the iris (or PAI) using different polarization configurations, the artificial birefringent features produced by the PAI will only be correctly rendered in one of the images, i.e. the image being captured utilizing the polarization configuration to which the PAI is adapted, both not in the other image being captured utilizing a different polarization configuration to which the PAI is not adapted.

Advantageously, the system will thus detect the PAI in that both the images will not correctly render birefringent features of a cornea.

In an embodiment, for each first image being captured, the first polarization configuration being applied is changed to a different polarization configuration.

In an embodiment, for each second image being captured, the second polarization configuration being applied is changed to a different polarization configuration.

In an embodiment, said different polarization configuration is selected randomly.

In an embodiment, a time period between the capturing of the first image and the second image is selected to vary.

In an embodiment, the time period between the capturing of the first image and the second image is selected to vary randomly.

In an embodiment, the method further comprises capturing at least one further image comprising a representation of the iris, which at least one further image is captured utilizing polarized light reflected at the iris and received at the polarization-sensitive camera capturing said at least one further image, the at least one further image being captured with a further polarization configuration being applied.

In an embodiment, wherein if after a set number of failed attempts have been made to detecting, from the representations of the iris of the first and second images, whether birefringent features of a cornea are correctly rendered in both the first and the second image, the user is required to prove knowledge of secret credentials before further attempts are allowed.

In an embodiment, the polarization if light is caused by emitting light through a first polarization filter having a first set of polarization properties and the polarization sensitivity being caused by receiving the polarized light reflected by the iris at the camera via a second polarization filter having a second set of polarization properties.

In an embodiment, the first and second polarization configurations are determined by the polarization properties of the first and second polarization filters.

In an embodiment, the first image is captured by a first image sensor of the polarization-sensitive camera, while the second image is captured by a second image sensor of the polarization-sensitive camera, the first image sensor receiving the polarized light reflected by the iris at the camera via the second polarization filter having a second set of polarization properties, and the second image sensor receiving the polarized light reflected by the iris at the camera via a third polarization filter having a third set of polarization properties.

In an embodiment, the method further comprises comparing the detected birefringent cornea features of at least one of the images with previously enrolled birefringent cornea features, and if there is a match authenticating an individual associated with the detected birefringent cornea features.

In an embodiment, the method further comprises detecting, from the acquired representation, iris, face or periocular features, and comparing the detected iris, face or periocular features with previously enrolled iris, face or periocular features; and if there is a match an individual associated with the detected iris, face or periocular features is authenticated.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 illustrates a user being located in front of a smart phone, in which embodiments may be implemented;

FIG. 2 shows a camera image sensor being part of an iris recognition system according to an embodiment;

FIG. 3a illustrates a user being subjected to unpolarized light for iris image capture;

FIG. 3b illustrates a user being subjected to polarized light for iris image capture by a polarization-sensitive camera according to an embodiment;

FIG. 4a illustrates an eye being subjected to unpolarized light;

FIG. 4b illustrates an eye being subjected to polarized light where a polarization-sensitive camera will capture images comprising birefringent features of the cornea according to an embodiment;

FIG. 5 shows a flowchart of a method of a biometric recognition system of performing real-eye detection according to an embodiment;

FIG. 6 illustrates different appearances of birefringent features of the cornea of the user when selecting different sets of polarization properties of polarizing filters;

FIG. 7 illustrates a user being subjected to polarized light for iris image capture by a polarization-sensitive camera being equipped with dual images sensors according to an embodiment;

FIG. 8 shows a flowchart of a method of a biometric recognition system of performing real-eye detection and further birefringent cornea feature authentication according to an embodiment;

FIG. 9 illustrates three different authentication responses (a)-(c) according to embodiments; and

FIG. 10 shows a flowchart of a method of a biometric recognition system of performing real-eye detection and further iris feature authentication according to an embodiment.

### DETAILED DESCRIPTION

The aspects of the present disclosure will now be described more fully hereinafter with reference to the accompanying drawings, in which certain embodiments of the invention are shown.

These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

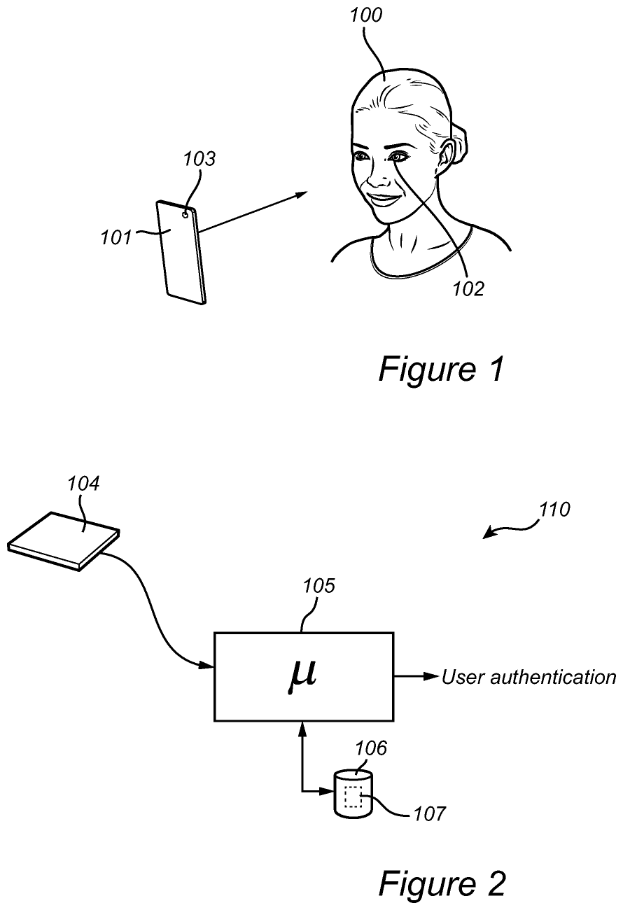

FIG. 1 illustrates a user 100 being located in front of a smart phone 101. In order to unlock the smart phone 101, a camera 103 of the smart phone 101 is used to capture one or more images of an eye 102 of the user 100.

After having captured the image(s), the user's iris is identified in the image(s) and unique features of the iris are extracted from the image and compared to features of an iris image previously captured during enrolment of the user 100. If the iris features of the currently captured image—at least to a sufficiently high degree—correspond to those of the previously enrolled image, there is a match and the user 100 is authenticated. The smart phone 101 is hence unlocked.

It should be noted that this is exemplifying only, and that authentication may be utilized for numerous purposes, such as e.g. unlocking a vehicle to be entered by a user, allowing a user to enter a building, to perform a purchase at a point-of-sale terminal, etc, using appropriately adapted iris recognition systems.

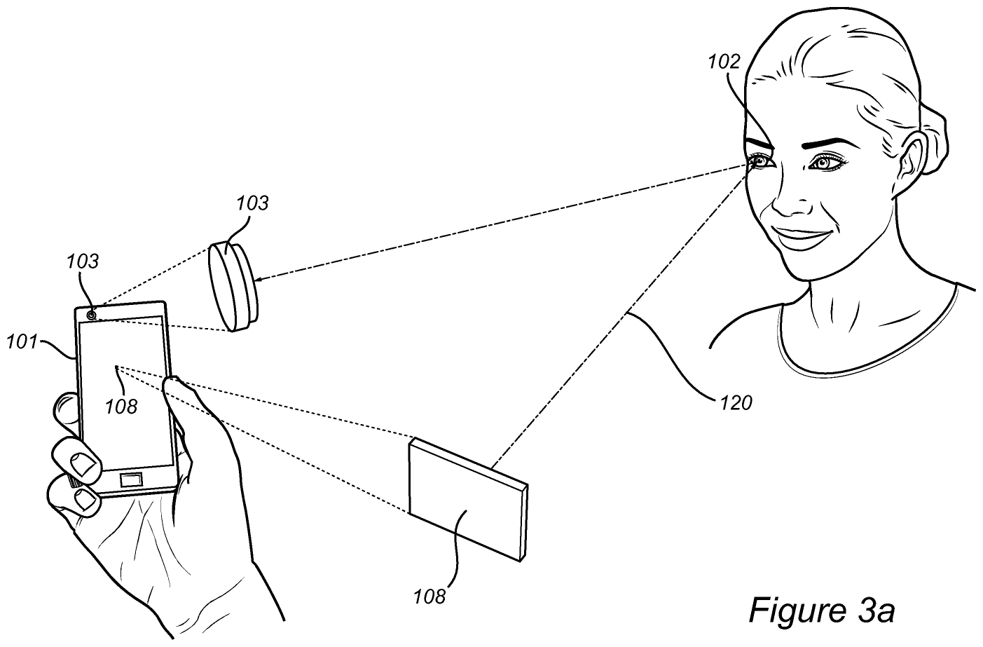

FIG. 2 shows a camera image sensor 104 being part of a biometric recognition system 110 according to an embodiment implemented in e.g. the smart phone 101 of FIG. 1. The system will be referred to as an iris recognition system but may alternatively be used to recognize face-or periocular features of an individual. The iris recognition system 110 comprises the image sensor 104 and a processing unit 105, such as one or more microprocessors, for controlling the image sensor 104 and for analysing captured images of one or both of the eyes 102 of the user 100. The iris recognition system 110 further comprises a memory 106. The iris recognition system 110 in turn, typically, forms part of the smart phone 100 as exemplified in FIG. 1.

The camera 103 will capture an image of the user's eye 102 resulting in a representation of the eye being created by the image sensor 104 in order to have the processing unit 105 determine whether the iris data extracted by the processing unit 105 from image sensor data corresponds to the iris of an authorised user or not by comparing the iris image to one or more authorised previously enrolled iris templates pre-stored in the memory 106.

With reference again to FIG. 2, the steps of the method performed by the iris recognition system 110 are in practice performed by the processing unit 105 embodied in the form of one or more microprocessors arranged to execute a computer program 107 downloaded to the storage medium 106 associated with the microprocessor, such as a RAM, a Flash memory or a hard disk drive. Alternatively, the computer program is included in the memory (being for instance a NOR flash) during manufacturing. The processing unit 105 is arranged to cause the iris recognition system 110 to carry out the method according to embodiments when the appropriate computer program 107 comprising computer-executable instructions is downloaded to the storage medium 106 and executed by the processing unit 105. The storage medium 106 may also be a computer program product comprising the computer program 107. Alternatively, the computer program 107 may be transferred to the storage medium 106 by means of a suitable computer program product, such as a Digital Versatile Disc (DVD) or a memory stick. As a further alternative, the computer program 107 may be downloaded to the storage medium 106 over a network. The processing unit 105 may alternatively be embodied in the form of a digital signal processor (DSP), an application specific integrated circuit (ASIC), a field-programmable gate array (FPGA), a complex programmable logic device (CPLD), etc.

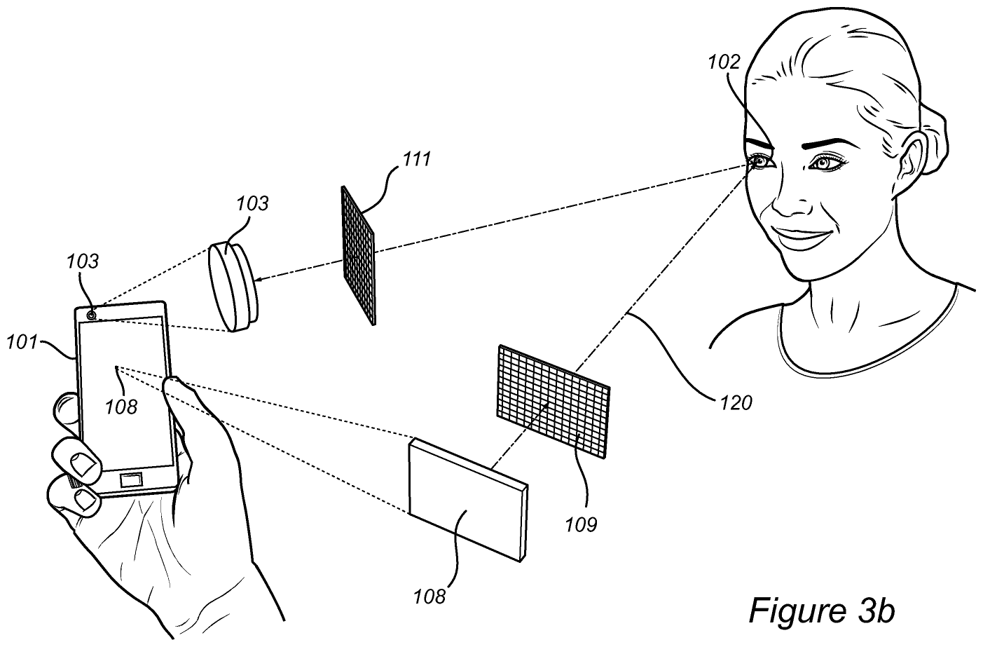

Now, with reference to FIG. 3a, in an example it is assumed that unpolarized light 120 is being emitted e.g. by light-emitting elements 108 of a screen of the smart phone 101 or by a camera flash travelling in a path from the smart phone 101 to the eye 102 of the user and back to an image sensor of the camera 103.

In FIG. 3b, it is assumed that the emitted light 120 travelling in a path from the smart phone 101 to the eye 102 of the user and back to the image sensor of the camera 103 is polarized. In this particular example, the polarization of the light 120 is caused by a first polarizing filter 109 arranged at the light-emitting elements 108, for instance being implemented in the form of a polarizing film attached to the screen of the smart phone 101. Further in FIG. 3b, a second polarizing filter 111 is arranged at the camera 103, for instance being implemented in the form of a polarizing film attached to a lens of the camera 103.

Thus, the camera 103 must be polarization-sensitive in order to be able to perceive the polarized light 120 being reflected against the eye 102 and impinging on the image sensor of the camera 103.

In practice, the image sensor 104 of FIG. 2 may be a polarization image sensor where pixel responses vary according to polarization characteristics of the light impinging on the sensor. In other words, an image sensor which is intrinsically selective to polarization by means of a polarizer (i.e. equivalent to the second filter 111 being arranged inside the camera 103 at the image sensor 104) may advantageously be utilized. However, for illustrative purposes, a separate polarization filter 111 is used, which also may be envisaged in a practical implementation as a less expensive alternative to the polarization image sensor. As will be discussed below, it may be envisaged that the camera is equipped with dual image sensors.

Now, a human cornea—i.e. the outer membrane in front of the iris—exhibits birefringent properties that are apparent in a captured image when the iris is illuminated with polarized light and the image is captured with a polarization-sensitive camera 103.

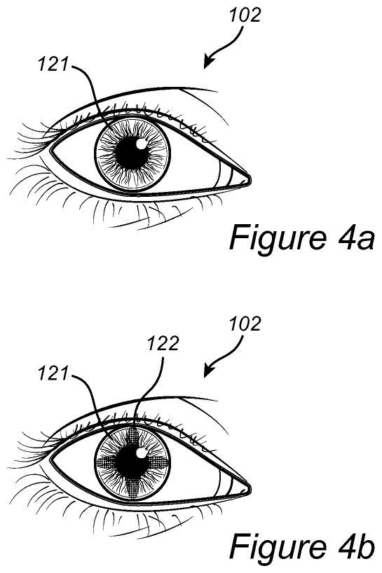

Thus, as shown in FIG. 4a corresponding to the scenario of FIG. 3a where the eye 102 is subjected to unpolarized light, a “normal” iris 121 will be present in the image captured by the camera 103 whereas in FIG. 4b corresponding to the scenario of FIG. 3b where the eye 102 is subjected to polarized light, birefringent features 122 of the cornea will be present in the image captured by the polarization-sensitive camera 103 caused by the polarized light impinging on the cornea covering the iris 121. As is understood, should a camera be used which is not polarization-sensitive, the birefringent features will not be present in the captured image, even if the light 120 travelling towards the eye is polarized.

Thus, an image captured by the polarization-sensitive camera 103 while subjecting the iris 121 to polarized light will comprise birefringent cornea features 122 and may thus be utilized for detecting whether the eye 102 is a real, authentic eye or not.

For instance, assuming that an attacker subjects the iris recognition system 110 to a spoof attempt where the attacker presents e.g. a printout of a user's iris. Such a printout will not comprise the birefringent cornea features 122 of the eye 102 of the user, even if it should be noted that iris features of this printout may correspond perfectly to those of the user. Thus, if no birefringent features are detected in the captured image, the system 110 terminates the authentication process since the presented iris is not deemed to originate from a real eye.

Now, it may be possible that the attacker subjects to system 110 to more complex and elaborated spoofing attempts, using so-called iris Presentation Attack Instruments (PAI) and in particular birefringent PAIs. Even though reproduction of a 3D material with similar birefringent properties as a real cornea is not currently feasible, it is possible to manufacture 2D PAIs that show similar patterns when illuminated with a particular target configuration, e.g. by providing a print-out of an iris with patches of birefringent material on top to create a structure similar to a cornea.

With such a PAI, it may be possible to spoof the real-eye detection above, in particular if physical properties of the PAI is adapted to a particular polarization configuration of system.

In an embodiment, this problem is resolved by capturing at least two images of the iris 121 using different polarization configurations and determining from the two captured images whether or not detected birefringent cornea features 122 are correctly rendered in both of the captured images. If so, the eye 102 will be determined to be a real, authentic eye; a PAI while only be able to produce correctly rendered birefringent cornea features for the polarization configuration to which it is adapted.

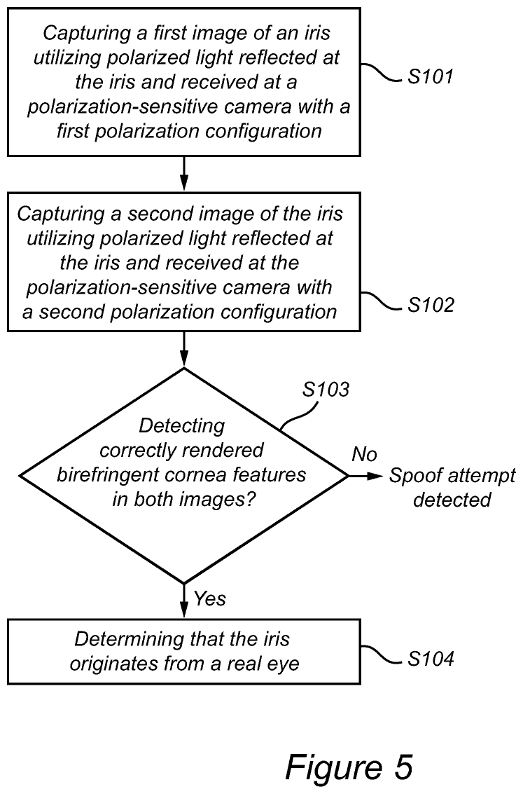

FIG. 5 shows a flowchart of a method of performing real-eye detection according to this embodiment

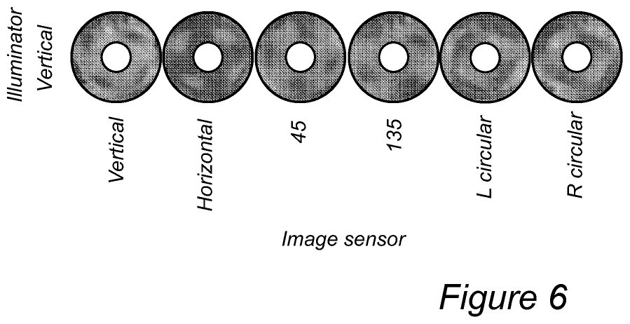

Reference will further be made to FIG. 6, where different polarization configurations are illustrated to result in different birefringent cornea feature appearances.

FIG. 6 illustrates different appearances of birefringent features of the cornea of the user in case of the light emitted by the light-emitting elements 108 is vertically polarized by the first polarizing filter 109 while the light received at the camera 103 is vertically, horizontally, 45°, 135°, left circularly and right circularly polarized, respectively, by the second polarizing filter 111 (or by an intrinsic polarizer in case a polarization image sensor is used). As is understood, the first polarizing filter 109 could also be configured to have any one of a vertically, horizontally, 45°, 135°, left circularly and right circularly polarization, which in this particular example potentially would result in 6×6=36 different appearances of the birefringent cornea features.

Hence, the appearance of the birefringent features depends on the combination of polarization configuration selected for the first polarizing filter 109 and the second polarizing filter 111.

As mentioned, an attacker using a sophisticated PAI may succeed in spoofing a system using a PAI adapted to a particular polarization; for instance, the PAI could be adapted to spoof a system where the first polarization filter 109 utilizes a vertical polarization configuration while the second polarization filter 111 utilizes a 45° polarization configuration.

In the flowchart of FIG. 5, in a first step S101, the polarization-sensitive camera 103 is controlled (typically by the processing unit 105) to capture a first image of an iris 121, which image is captured utilizing polarization of light 120 received at the image sensor 104 of the camera 103. As previously discussed, in this example the polarization is caused by the first polarizing filter 109, while the second polarization filter 111 causes the camera 103 to become polarization-sensitive (although a polarization image sensor may be used as previously discussed).

The first image is thus captured utilizing a first polarization configuration as determined by the first filter 109 and the second filter 111. For example, the first polarization configuration may be embodied by the first filter 109 using vertical polarization while the second filter 111 using horizontal configuration.

In a second step S102, the polarization-sensitive camera 103 is controlled to capture a second image of the iris 121 utilizing a second polarization configuration. For instance, the second polarization configuration may be embodied by both the first filter 109 and the second filter 111 using vertical polarization.

One or both of the polarization filters 109, 111 may be configured to be electrically controllable to change polarization. In this particular example, the processing unit 105 would control the second filter 111 to change polarization configuration from horizontal to vertical after having captured the first image but before capturing the second image.

The first image will thus comprise birefringent cornea features having the appearance shown in the next-most left illustration of FIG. 6 while the second image will comprise birefringent cornea features having the appearance shown in the far left illustration of FIG. 6, i.e. corresponding to the two different polarization configurations utilized.

The birefringent features 122 of the cornea of the eye 102 being present in the first image and the second image are detected by the processing unit 105 in step S103, and the processing unit 105 concludes in step S104 that the iris 121 of the captured images indeed originates from a real eye, since the birefringent cornea features are correctly rendered in both images, i.e. the detected birefringent cornea features will have the appearance as expected depending on the selected polarization configuration for each of the two captured images.

As mentioned hereinabove, if a PAI is presented to the iris recognition system 110, it may be possible to spoof the system with one of the images, e.g. the first image, assuming that the physical structure of the PAI is adapted to the polarization configuration being applied to the first image.

However, in such case, the artificial birefringent features produced by the PAI will only be correctly rendered in the first image, which utilizes the polarization configuration to which the PAI is adapted, both not in the second image being captured utilizing a different polarization configuration to which the PAI is not adapted.

Thus, assuming that the physical structure of the PAI is adapted to the first polarization configuration and the attacker manages to spoof the system 110 into detecting birefringent cornea features in the first image, the second image being captured of the PAI utilizing the second polarization configuration will not comprise correctly rendered birefringent cornea features, i.e. the detected birefringent PAI cornea features of the second image will not have the appearance that would be expected upon the second polarization configuration being applied (cf. FIG. 6) as concluded in step S103, and the spoof attempt is advantageously detected.

In FIG. 3b, a polarization-sensitive camera 103 using a single image sensor is described in which case the first image is captured at a given instance in time utilizing the first polarization configuration and the second image is captured slightly later in time when the second polarization configuration has been applied.

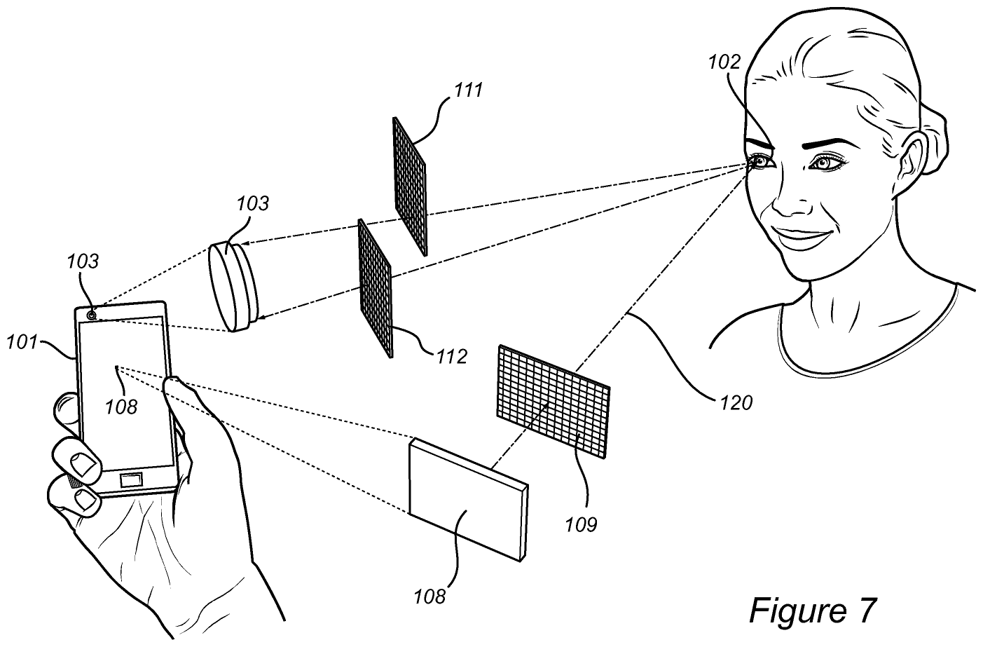

FIG. 7 illustrates an alternative embodiment where the polarization-sensitive camera 103 is equipped with dual image sensors, a first image sensor being illuminated by polarized light vid the second polarization filter 111 and a second image sensor being illuminated by polarized light via a third polarization filter 112.

In such an embodiment, similar to the embodiment described hereinabove with reference to the flowchart of FIG. 5, in a first step S101 the polarization-sensitive camera 103 is controlled by the processing unit 105 to capture a first image of the iris 121 with the first image sensor utilizing a first polarization configuration caused by the combination of the first polarization filter 109 (vertical) and the second filter 111 (horizontal).

Simultaneously, in step S102, the polarization-sensitive camera 103 is controlled by the processing unit 105 to capture a second image of the iris 121 with the second image sensor utilizing a caused polarization configuration caused by the combination of the first polarization filter 109 (vertical) and the third filter 112 (vertical).

With this embodiment, since the camera 103 is equipped with dual images sensors, the first image and the second image are captured simultaneously, and there is no need to change polarization of the filters, even though electrically controllable polarization filters 109, 111, 112 indeed may be employed.

Similar to the discussion hereinabove, if a PAI is presented to the iris recognition system 110, it may be possible to spoof the system in one of the captured images assuming that the physical structure of the PAI is adapted to the polarization configuration being applied in either the first or the second image.

However, the birefringent features produced by the PAI will only be correctly rendered in the image utilizing the polarization configuration to which the PAI is adapted, both not in the other image being captured utilizing a different polarization configuration.

Thus, assuming that the physical structure of the PAI is adapted to the first polarization configuration and the attacker manages to spoof the system 110 into detecting birefringent cornea features in the first image, the second image being captured of the PAI will not comprise correctly rendered birefringent cornea features as concluded in step S103 and the spoof attempt is advantageously detected, while for a real eye, correctly rendered birefringent features will be detected in step S103 both the first image and the second image resulting in successful real-eye determination in step S104.

As is understood, it may be envisaged that further images are captured using other polarization configurations in order to further increase the security level of the system 110; for instance a third image may be captured utilizing a third polarization configuration, a fourth image may be captured utilizing a fourth polarization configuration, etc., where birefringent cornea features should be correctly rendered in all the captured images for the iris to be assessed as originating from a real eye.

In further embodiments, if it is assumed that even more sophisticated PAIs may be created which could be adapted to produce birefringent cornea features for more than a single target polarization configuration-for instance a couple of target polarization configurations-the iris recognition system 110 will be configured change polarization configuration for each image being captured in order to avoid a scenario where a sophisticated PAI happens to be adapted to two different subsequent polarization configurations being applied.

These embodiments will be described below with reference to the setup of FIG. 3b, but could just as well be applied in the setup of FIG. 7.

A number of different configurations are envisaged:
a) for each second image being captured in step S102, the second polarization configuration being applied is changed; for instance if the previously utilized second polarization configuration caused by the second polarization filter 111 was 45°, the currently utilized second polarization configuration is set to be left-circular,
b) for each first image being captured in step S101, the first polarization configuration being applied is changed; for instance if the previously utilized first polarization configuration caused by the second polarization filter 111 was 135°, the currently utilized second polarization configuration is set to be right-circular,
c) a combination of embodiments a) and b) may be envisaged where both the first polarization configuration and the second polarization configuration is changed for each of the first and second images being captured,
d) the changes in polarization configurations are controlled to be performed in a random manner in order to hamper an attacker from predicting which polarization configuration will be applied next, and
e) the time period between the capturing of the first image and the second image is selected to vary and thus continuously change, for instance being randomized. In one scenario, the time period between the capturing of the first image and the second image is, say, 50 ms while in another scenario the time period is 100 ms and in a third scenario the time period is 75 ms. The advantage of this embodiment is that the attacker must guess the instants in time at which a second PAI (adapted to the second polarization configuration) should be presented for capturing the second image, making the probability of correctly predicting the sequence even lower.

The probability of correctly predicting polarization configurations for a sequence comprising N images where M possible polarization configurations may be applied is:

p=M^{-N}

Hence, as an example, if the first filter 109 is fixed while the second filter 111 is configured to be controllable to produce six different polarization configurations as illustrated in FIG. 6 and a first and second image is captured, the probability of correctly predicting the two polarization configurations is p=6⁻²=2.78%.

In a further embodiment, it is envisaged that if after a number of failed detection attempts have been made in step S103, such as two failed attempts, the iris recognition system 110 enters a breach mode, where the user is required to prove knowledge of secret credentials, for instance enter a pin code, before any further attempts can be made.

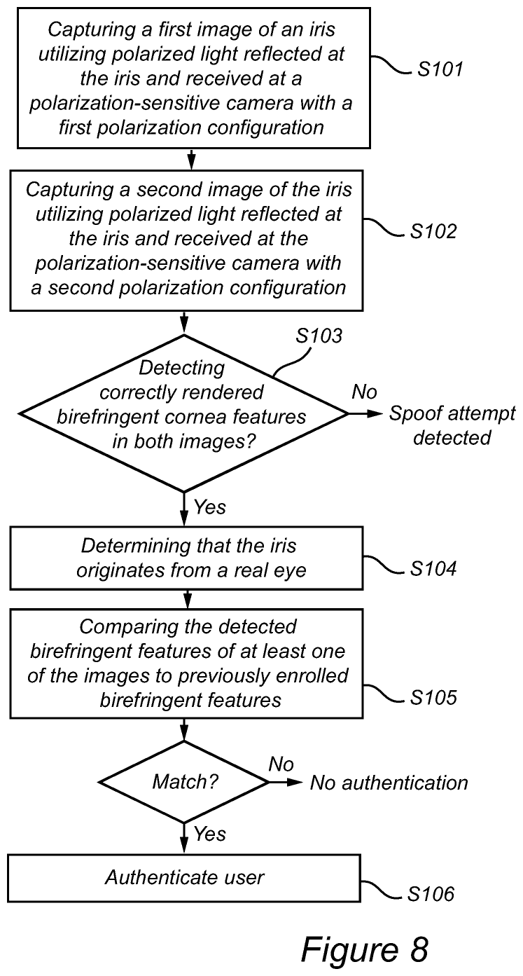

FIG. 8 illustrates a further embodiment where the detected birefringent cornea features further are utilized to authenticate a user.

As previously discussed with reference to FIG. 6, the birefringent features 122 will have different appearances depending on the polarization configuration used, as determined by the first and second polarizing filters 109, 111, and are distinctive to the user 100. A user will typically exhibit characteristic birefringent features for each given configuration, from which characteristic birefringent features the user may be recognized.

In the embodiment of FIG. 8, this is exploited to authenticate an individual, for instance with the purpose of e.g. unlocking the smart phone 101 or allow a user to start a car in case the system is implemented in the car.

Thus, if after the processing unit 105 has determined in step S104 that the iris indeed originates from a real eye, the birefringent cornea features detected in step S103 (of either the first image, the second image, or both) is compared in step S105 to previously enrolled birefringent cornea features of templates stored in the memory 106 of the iris recognition system 110 and if there is a match between the detected birefringent features and the previously enrolled birefringent features, the user is authenticated in step S106.

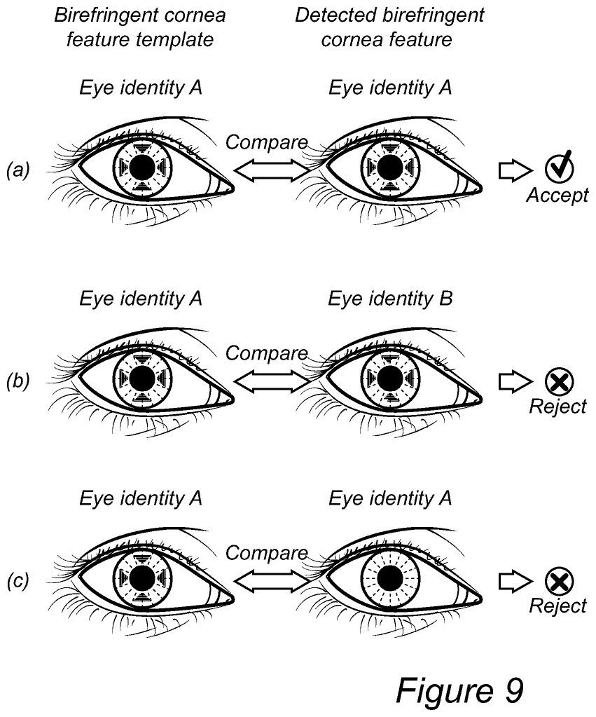

FIG. 9 illustrates three different authentication scenarios to which reference will be made.

In first scenario (a), the birefringent cornea features detected in step S103 from the image(s) captured in steps S101 and/or S102 are compared in step S105 to the previously enrolled birefringent cornea features of the templates stored in the memory 106 and since in this scenario there is a match between the detected birefringent features and the previously enrolled birefringent features, the user is authenticated in step S106. In other words, the identity of the user 100 associated with the detected birefringent features of step S103 must indeed correspond to identity A associated with the birefringent feature template pre-stored in the memory 106.

In second scenario (b), the birefringent cornea features detected in step S103 from the image(s) captured in steps S101 and/or S102 are compared in step S105 to the previously enrolled birefringent cornea features of the templates stored in the memory 106. However, since the detected birefringent features do not match the birefringent feature template in step S105, authentication is not successful. Thus, the detected birefringent features of step S103 cannot correspond to enrolled identity A but rather a different identity, in this example denoted identity B. As a result, the user is rejected.

In third scenario (c), an attempt is made in step S103 to detect birefringent cornea features from the image(s) captured in steps S101 and/or S102 but since in this scenario no birefringent features can be detected, the system 110 concludes that a spoof attempt has occurred where an attacker presents e.g. a printout of a user's iris. It should be noted that iris features of this printout nevertheless may correspond perfectly to those of the user. As a result, the authentication process is terminated

In a further embodiment, in addition to (or alternatively to) performing authentication based on detected birefringent cornea features, further detected biometric features of the captured image(s) may also be considered.

It is noted that birefringent features of the cornea typically are less expressive than face features and even more so when compared to iris features. Thus, in a scenario where high security and reliability is required in the authentication process, the birefringent cornea feature detection described hereinabove is expanded upon such that iris feature detection and/or face feature detection and subsequent iris/face feature authentication further is undertaken.

Further envisaged biometric features to be utilized include those in the so-called periocular region, which is the area around the eye including features like eyelashes, eyebrows, eyelids, eye shape, tear duct, skin texture, etc.

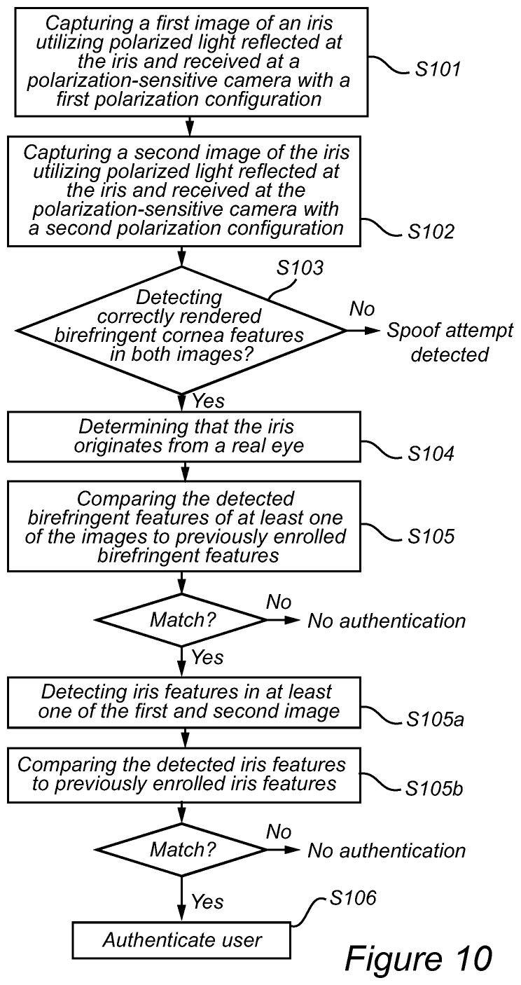

FIG. 10 illustrates this embodiment, wherein after it has been determined that the detected birefringent cornea features matches those previously enrolled, iris features are detected in one or both of the captured images in step S105a. It is noted that the detection of iris features not necessarily is affected by the polarization filters 109, 111. For instance, as illustrated in FIG. 4b, features of the iris 121 will be present in a captured image along with birefringent cornea features 122.

Thereafter, the processing unit 105 compares the detected iris features to previously enrolled iris feature template(s) in step S105b.

If there is a match also for the compared iris features, the user 100 is authenticated in step S106. If not, authentication fails.

Advantageously, not only is the level of security and reliability raised in the authentication process, but liveness detection is further provided by means of the birefringent cornea feature detection. In other words, if the presented iris is a spoof, no birefringent cornea features will be detected and the authentication will be terminated in the match operation undertaken in step S103.

As is understood, if for some reason the iris features are difficult to detect in in the captured image(s) being subject to polarized light, appropriate image processing may be applied, such as filtering, before the iris detection. As a further alternative, an image not being subjected to polarization is captured from which the iris features are detected.

In yet an alternative, an unpolarized image may be reconstructed by combining multiple polarized images. For example, the first image may be captured in step S101 obtained with orthogonal polarizers (e.g. first filter 109 at 0° degrees and second filter 111 at 90°), in which the birefringent cornea features are detected. The second image may be captured using parallel polarizers (e.g. both the first filter 109 and the second filter 111 at 0°). The first and the second polarized images are then combined to create an unpolarized image from which the iris features are detected, for instance by accumulating the image data of one of the images with the image data of other.

While FIG. 10 illustrates that authentication is based on both detected birefringent cornea features (cf. S105) and detected iris features (cf. S105b), it may be envisaged that step S105 is omitted and that after the processing unit 105 has determined in step S104 that the iris indeed originates from a real eye, the process proceeds to step S105b for performing the authentication based on iris features only.

The aspects of the present disclosure have mainly been described above with reference to a few embodiments and examples thereof. However, as is readily appreciated by a person skilled in the art, other embodiments than the ones disclosed above are equally possible within the scope of the invention, as defined by the appended patent claims.

Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method of a biometric recognition system of performing real-eye detection, comprising:
capturing a first image comprising a representation of an iris, which first image is captured utilizing polarized light reflected at the iris and received at a polarization-sensitive camera capturing said first image, the first image being captured with a first polarization configuration being applied;
capturing a second image comprising a representation of the iris, which second image is captured utilizing polarized light reflected at the iris and received at a polarization-sensitive camera capturing said second image, the second image being captured with a second polarization configuration being applied;
detecting, from the representations of the iris of the first and second images, whether birefringent features of a cornea are correctly rendered in both the first and the second image; and if so:
determining that the iris originates from a real eye.

2. The method of claim 1, wherein for each first image being captured, the first polarization configuration being applied is changed to a different polarization configuration.

3. The method of claim 1, wherein for each second image being captured, the second polarization configuration being applied is changed to a different polarization configuration.

4. The method of claim 2, wherein said different polarization configuration is selected randomly.

5. The method of claim 1, wherein a time period between the capturing of the first image and the second image is selected to vary.

6. The method of claim 5, wherein the time period between the capturing of the first image and the second image is selected to vary randomly.

7. The method of claim 1, further comprising
capturing at least one further image comprising a representation of the iris, which at least one further image is captured utilizing polarized light reflected at the iris and received at the polarization-sensitive camera capturing said at least one further image, the at least one further image being captured with a further polarization configuration being applied.

8. The method of claim 1, wherein if after a set number of failed attempts have been made to detecting, from the representations of the iris of the first and second images, whether birefringent features of a cornea are correctly rendered in both the first and the second image, the user is required to prove knowledge of secret credentials before further attempts are allowed.

9. The method of claim 1, wherein the polarization if light is caused by:
emitting light through a first polarization filter having a first set of polarization properties; and the polarization sensitivity being caused by:
receiving the polarized light reflected by the iris at the camera via a second polarization filter having a second set of polarization properties.

10. The method of claim 9, the first and second polarization configurations being determined by the polarization properties of the first and second polarization filters.

11. The method of claim 10, wherein the first image is captured by a first image sensor of the polarization-sensitive camera, while the second image is captured by a second image sensor of the polarization-sensitive camera, the first image sensor receiving the polarized light reflected by the iris at the camera via the second polarization filter having a second set of polarization properties, and the second image sensor receiving the polarized light reflected by the iris at the camera via a third polarization filter having a third set of polarization properties.

12. The method of claim 1, further comprising:
comparing the detected birefringent cornea features of at least one of the images with previously enrolled birefringent cornea features; and if there is a match:
authenticating an individual associated with the detected birefringent cornea features.

13. The method of claim 12, further comprising:
detecting, from the acquired representation, iris, face or periocular features; and
comparing the detected iris, face or periocular features with previously enrolled iris, face or periocular features; and if there is a match an individual associated with the detected iris, face or periocular features is authenticated.

14. (canceled)

15. A computer program product comprising a non-transitory computer readable medium, the computer readable medium having a computer program embodied thereon, the computer program comprising computer-executable instructions for causing a biometric recognition system to perform the method of claim 1 when the computer-executable instructions are executed on a processing unit included in the biometric recognition system.

16. A biometric recognition system configured to perform real-eye detection, the system comprising a polarization-sensitive camera configured to:
capture a first image comprising a representation of an iris, which first image is captured utilizing polarized light reflected at the iris and received at a polarization-sensitive camera capturing said first image, the first image being captured with a first polarization configuration being applied;
capture a second image comprising a representation of the iris, which second image is captured utilizing polarized light reflected at the iris and received at a polarization-sensitive camera capturing said second image, the second image being captured with a second polarization configuration being applied; the system further comprising a processing unit configured to:
detect, from the representations of the iris of the first and second images, whether birefringent features of a cornea are correctly rendered in both the first and the second image; and if so:
determine that the iris originates from a real eye.

17. The biometric recognition system of claim 16, the processing unit further being configured to, for each first image being captured, change the first polarization configuration being applied to a different polarization configuration.

18. The biometric recognition system of claim 16, the processing unit further being configured to, for each second image being captured, change the second polarization configuration being applied to a different polarization configuration.

19. The biometric recognition system of claim 17, the processing unit further being configured to select said different polarization configuration randomly.

20. The biometric recognition system of claim 16, the processing unit further being configured to select a time period between the capturing of the first image and the second image to vary.

21. The biometric recognition system of claim 20, the processing unit further being configured to select the time period between the capturing of the first image and the second image is selected to vary randomly.

22.-28. (canceled)
